(19) United States
(12) Patent Application Publication
(10) Pub. No.: US 2007/0016897 A1
(43) Pub. Date: Jan. 18, 2007

(54) METHODS, APPARATUS AND COMPUTER PROGRAMS FOR OPTIMIZED PARSING AND SERVICE INVOCATION

(75) Inventor: Stephen James Todd, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/426,655

(22) Filed: Jun. 27, 2006

(30) Foreign Application Priority Data
Jul. 12, 2005 (GB) 05141911.6

(51) Int. Cl. G06F 9/45

(52) U.S. Cl. 717/143

(57) ABSTRACT

Provided are methods, apparatus and computer programs for optimized parsing and service invocation, as well as for optimized processing of responses to service requests. A set of parsing templates are stored in a tree for matching against common elements of incoming service requests, such as SOAP messages written in XML, avoiding the need to perform a full semantic parse of all elements of the input sequence. A service invocation template is identified in response to successful template-match and parse operation, allowing a service invoker to be directly called following the successful parse. In this way, an adaptive template-based parsing is followed by simplified service invocation, short-cutting some of the analysis that is required in a conventional processing sequence.

### FIELD OF INVENTION

The present invention relates to data processing and in particular to processing service requests and other messages for which the precise syntax is not known in advance of receipt of the request or message.

### BACKGROUND

An increasingly common processing paradigm involves passing a service request as a string in a standard format and using a standard protocol, such as using the Simple Object Access Protocol (SOAP), to enable execution by a service provider. SOAP enables a program running on a first operating system to communicate with programs running on a different type of operating system (as well as programs running on the same type or instance of operating system), using the World Wide Web's Hypertext Transfer Protocol (HTTP) and the extensible Markup Language (XML) as the mechanisms for information exchange. Since Web protocols are available for use by major operating system platforms, HTTP and XML can be used when solving the problem of how programs running under different operating systems in a network can communicate with each other. SOAP specifies how to encode an HTTP header and an XML file so that a program in one computer can call a program in another computer and pass information to the called program. SOAP also specifies how the called program can return a response.

A problem with SOAP messages is that they typically comprise excessively long input strings. XML is simple and flexible but also verbose, and a SOAP message including method calls and parameter values may include 1 KB (for example) of other information. Despite the use of standard formats, the precise syntax of all of this information will depend on the program and operating system from which the message originates. To prepare the input string for execution by the service provider, a conventional processing flow includes the steps of (1) parsing an incoming request's input string to identify mark up tags and data, (2) analyzing the result of the parsing step to determine requirements of the service request and matching against available services to identify an appropriate service object (or method and parameters), and (3) invoking the service. There is considerable processing overhead in this conventional flow, even before the final step of execution of the service itself.

The high processing overhead when parsing a message from scratch and performing subsequent processing is not limited to SOAP messages. For example, the problem applies generally to messages that are not maps of simple programming language structures, especially self-defining messages.

Currently there are three main technologies that are used to parse an XML document. Firstly, the Document Object Model (DOM) can be used to parse a complete document into a tree, and provides an API to traverse the tree and extract the data. Secondly, a simple API for XML (SAX) may be used to parse a document and provide events, optionally with data, to a user application. Thirdly, pull-parsing technology is a derivative of SAX where the user application is in charge of the looping mechanism that scans the document. Typically, each of these technologies suffers from a major disadvantage in that they must parse every new document from scratch, which is very time consuming.

T. Takase, H. Miyashita, T. Suzumura and M. Tatsubori, “An Adaptive, Fast, and Safe XML Parser Based on Byte Sequences Memorization”, Proceedings of the 14th international conference on World Wide Web (WWW2005), pages 692-701, May 10-14, 2005, Chiba, Japan, describes pattern-based parsing but does not address the cost of the above-mentioned analysis step (2) and invocation step (3).

### SUMMARY

A first aspect of the present invention provides a method for processing service requests in a data processing network, comprising the steps of: comparing a received service request with a set of stored parsing templates and applying a matching parsing template to extract service requirements information from the received service request; identifying a service invocation template associated with the matching parsing template; and applying the associated service invocation template to invoke a service matching the service requirements information.

The invention combines template-based parsing of an input sequence (typically an input string or byte array or byte stream—all referred to below as an ‘input sequence’ for simplicity) with an associated template-based invocation of services using the result of the template-based parsing. This avoids the need for a full semantic parse of the input sequence, if the input sequence matches a previously handled message or service request type. The invention also shortcuts the analysis and selection steps normally required for service invocation, by recognizing that a match with a parsing template allows selection of a service invocation template. Many data processing operations and different types of services can be efficiently invoked in this way.

The invention can achieve a significant reduction in processing overhead compared with conventional processing flows for self-defining messages and service requests such as SOAP service requests using XML. While the invention is applicable to Web services using SOAP messages, a ‘service request’ as defined herein may include any type of message or data communication that is sent from a first component of a data processing network to initiate processing by a component other than the first. Many data processing systems such as Web server systems providing Web services receive repetitive inputs from each of a small number of different types of service-requestor (perhaps thousands of requester systems, but a relatively small number of requestor application types and operating system types). One type of requestor may repeatedly request the same service. Therefore, a SOAP parser and dispatcher may only be required to cope with a small number of input formats and to invoke a small number (perhaps tens) of services. In a simple situation, an incoming XML message will represent a call to one of a small number of services and ‘pattern’ matching using templates according to the present invention can identify which parsing template to use and which service to invoke.

The method according to one embodiment comprises comparing an input sequence with a set of stored elements of previously processed input sequences, to identify a match. In response to a match, a previously stored result of parsing the matched element is retrieved from storage and reused, avoiding the need for repetitive parsing. For certain types of service request comprising an input string, some substrings and specific elements within the input string are included in any service request of that type. These common substrings and other common elements are identified and saved as elements of a template. Other elements of the input, such as specific parameter values, will vary between each message. The ability to differentiate between predefined common elements and variables allows a much lower parsing overhead compared with the overhead of parsing a long self-defining input string from scratch.

The step of applying a service invocation template comprises adding data extracted from the parsed input to predefined elements of a service invocation template to generate a call that is formatted for execution by a required service, and sending this service request call to the required service. The service invocation template typically includes an identifier of a method (for example an object or class name and a method name) and an identifier of any required parameter types for a required service. Some services will not require any parameters, in which case a simple service invocation comprising a method name will have a correspondingly simple service invocation template. The association between templates can be achieved by saving the parsing template with a pointer to an associated invocation template, such that matching and parsing using a template-based parser automatically triggers use of the associated invocation template.

A method for processing service requests according to one embodiment of the invention comprises three processing phases. An initial process comprises: parsing a received input sequence representing a first service request to identify service requirements of the first service request; comparing the identified service requirements with available services to identify a matching service; and invoking the matching service. The input string, results of the parse step and the service invocation are captured for subsequent reuse. Secondly, a template setup process comprises: generating a parsing template representing common elements of a type of service request matching the first service request, and generating a service invocation template representing service invocation requirements of a type of service request matching the first service request; and storing the parsing template and service invocation template as associated templates, for use with subsequent service requests of a type matching the first service request. Thirdly, a template-based parsing and service invocation process is performed. On receipt of a second input sequence representing a second service request of a type matching the first service request, the second input sequence is compared with at least one stored parsing template to identify a parsing template match, and the matched parsing template is applied to parse the second input sequence, to identify service requirements of the second service request. The associated service invocation template is then applied to invoke a service matching the service requirements of the second service request.

In one embodiment of the invention, the template setup process comprises adding the elements of a newly generated template to a template matching and parsing tree. A set of template elements are organized hierarchically at nodes of the tree such that each branch of the tree represents a different template. An input sequence of a new service request can then be compared with the template matching tree, iteratively comparing a next substring of an input string (or a next set of characters of another input sequence) with a next set of nodes of the tree, to select and apply a parsing template. The results of this selection and parsing are then used for a template-based service invocation. The combination of a template-based scan and parse operation followed by a template-based invocation can reduce parsing and analysis processing overhead compared with known alternatives.

Another aspect of the invention provides a data processing apparatus for dispatching service requests to required services, the apparatus comprising: a template generator for generating parsing templates and associated service invocation templates; a template-based parser; and a template-based service invoker.

Another aspect of the invention provides a method for processing service requests at a service listener system within a data processing network. The method comprises: analysing a first service invocation that is generated in response to a first service request of a first type, to identify service invocation elements that are common to service invocations resulting from service requests of the first type; and generating a service invocation template comprising the common service invocation elements, and storing the service invocation template for use with other service requests of the first type.

Another aspect of the invention provides a data processing apparatus comprising at least one service provider and a service request dispatcher for performing a method as described above. The service request dispatcher comprises a template generator for generating parsing templates and associated service invocation templates, a template-based parser, and a template-based service invoker.

Another aspect of the invention provides a method for processing input sequences in a data processing network, comprising the steps of: comparing a received input sequence with a stored set of parsing templates and applying a matching parsing template to parse the received input sequence, to identify requirements of an operation to be performed subsequent to said parse step; identifying a second stored template, associated with the matching parsing template, for initiating the subsequent operation; and applying the second stored template to initiate the subsequent operation.

Another aspect of the invention provides a method for processing input sequences at a service requester system within a data processing network, wherein an input sequence is received by the service requester system in response to a service request, the method comprising: analysing a first input sequence received in response to a first type of service request, to identify elements of the first input sequence that will be constant between the first input sequence and other input sequences received in response to service requests of said first type; and generating and storing a response parsing template comprising the constant elements, for handling input sequences received in response to service requests of said first type. The method enables subsequent processing steps to be simplified. When input sequences are received in response to service requests of the first type, they can be parsed using the response parsing template.

### BRIEF DESCRIPTION OF DRAWINGS

Embodiments of the invention are described below in more detail, by way of example, with reference to the accompanying drawings in which:

FIG. 1 shows some of the components of a server data processing system for use in a service-oriented data processing network, as is known in the art;

FIG. 2 shows a simple processing sequence for SOAP message parsing and service invocation, as is known in the art;

FIG. 3 shows components of a data processing system according to an embodiment of the invention;

FIG. 4 shows a sequence of operations of an initial process for handling a received service request, according to a first embodiment of the invention;

FIG. 5 shows a sequence of operations for a template setup process, according to the first embodiment;

FIG. 6 shows an example tree structure for a set of example templates;

FIG. 7 shows a sequence of operations for template-based parsing and service invocation, according to the first embodiment;

FIG. 8 shows the operations of an example parser;

FIG. 9 is an overview representation of the operations of FIGS. 4, 5 and 7; and

FIG. 10 is an overview representation of operations according to a second embodiment of the invention.

### DESCRIPTION OF EMBODIMENTS

Described below are components and processes implementing the present invention for optimized handling of input sequences such as service requests. The input sequence may be a string, a byte array or a byte stream, and the following description takes the example of an input string. The term ‘service request’ should be interpreted to include Web services requests and any type of message or data communication that is sent from a first component of a data processing network to initiate processing by a component other than the first component. The invention is applicable to messages for which the precise syntax is not known by a recipient before the message is received; especially self-defining messages such as SOAP messages using XML. The invention may be implemented in many different types of data processing apparatus and various components of the apparatus may be implemented in hardware or software. The invention may be used for efficient invocation of many data processing operations including to invoke many different types of services.

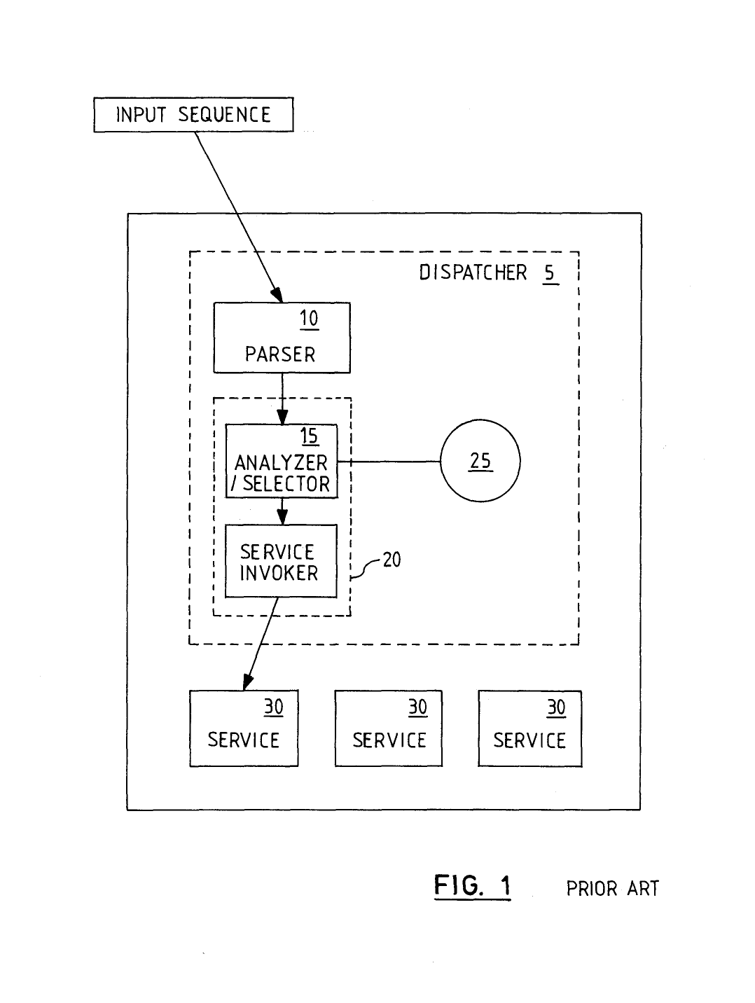

A typical requirement of a server system in a service-oriented data processing environment is the ability to handle self-defining messages—i.e. messages for which the precise syntax is not known before the message is received. For example, a server system may receive differently-formatted SOAP messages from each of a plurality of different types of service requestor, and some initial processing is required before a requested service can process received requests. As shown in FIG. 1, a typical server system includes a parser 10, for processing a markup language input string to extract markup tags and data, and a service selector and invoker 20. The parser and selector/invoker are implemented as separate components, for example as distinct code sequences within a request dispatcher 5. The system also includes a plurality of service objects 30 that each encapsulate methods and parameters for performing requested services. The parser, selector/invoker and service objects are typically implemented in computer software, although this is not essential.

Although the description below refers to input strings as the example input sequence to be processed, the input sequence may be a byte sequence other than a string. In a Java™ implementation, a binary-encoded UTF-8 string may not be converted to a Java string (i.e. may not be interpreted as a string), and indeed may be parsed on the fly as the data is received as a byte stream.

The selector and invoker 20 may comprise a plurality of components including an analysis component 15 connected to a repository of service requirements information 25 to enable matching of service requirements for service selection, and a service invoker connected to receive its input from the analysis component and to make calls to a selected service object. Alternatively, the analysis component may pass its output to a handler manager that accesses suitable handlers for the type of received service request. The handler manager then calls the service invoker which calls a service object. These potential modifications demonstrate that the system shown in FIG. 1 is merely one simple example of known server systems.

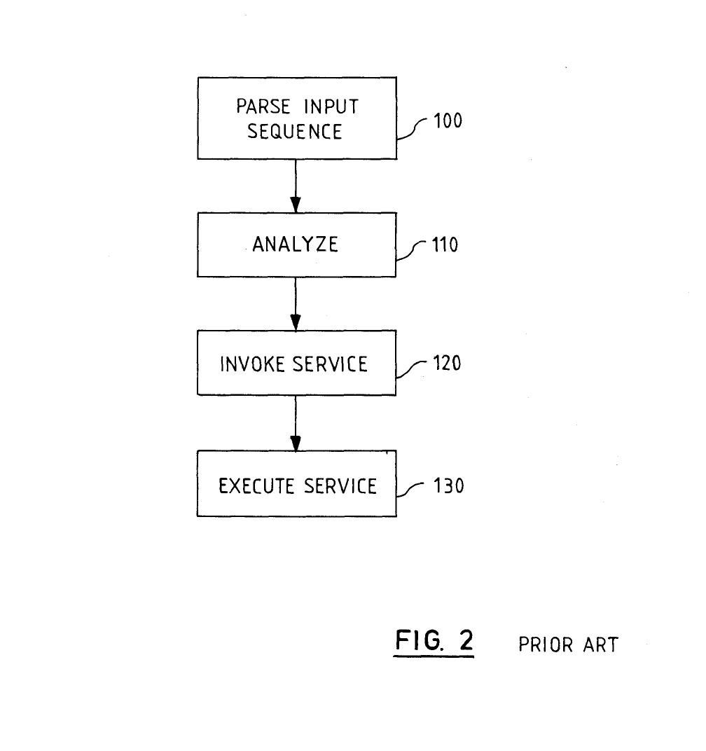

FIG. 2 shows a simple processing sequence when the known server system of FIG. 1 receives a SOAP message as an input string. The parser 10 of the server system parses 100 the input string to extract XML tags and tag-delimited data. The result of this parsing step is then analyzed 110 to determine service requirements from the extracted tags and data, and to select a service to process the request; and the service requirements information is passed to the service invoker which invokes 120 a service. A method is executed 130 by the invoked service.

System Components and Overview

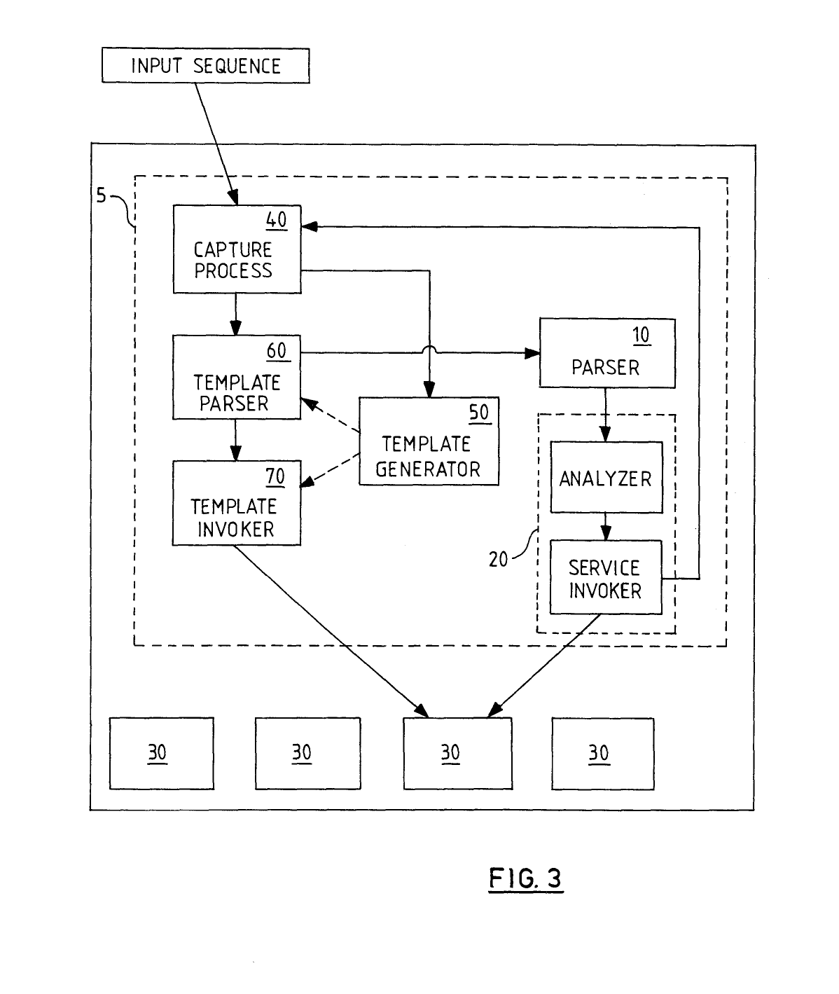

FIG. 3 shows components of a data processing apparatus for service request handling according to an embodiment of the present invention. As in FIG. 1, the apparatus includes a parser 10, for processing an input string to extract markup tags and tag-delimited data, a service selector and invoker 20, and a plurality of service objects 30 (or, equivalents, non-object-oriented methods and parameters) for performing requested services. However, unlike FIG. 1, the dispatcher 5 shown in FIG. 3 includes a capture component 40 for capturing input and output strings and for capturing parameters and service details for a service request. The apparatus also includes a template generator 50, a template-based parser 60, and a template-based service invoker 70.

The template generator 50 generates two types of template—a parsing template and an associated service invocation template. The parsing template comprises a set of structural elements of a particular type of input message—for example substrings representing the parts of an XML message that are expected to be repeated within other requests from the same requester type for the same service—and inserts to indicate places in the messages where variation can be expected between one message and the next. Each parsing template provides a structural definition of the message type and indications of where to insert data that is specific to an individual message, and can be used to simplify parsing when matched with an input message string. The template generator 50 stores each new parsing template within a tree structure in cache storage, adding to the tree when a new input message type necessitates generation of a new template.

The service invocation template comprises: an identification of an object (or class of object) to be invoked; a method to be invoked; and a set of zero, one or more parameters (parameter types) and their order. A service invocation template and a parsing template generated from an input string are stored in association with each other in cache storage so that, for future input strings of the same type, identification of a matching parsing template inherently identifies the associated service invocation template.

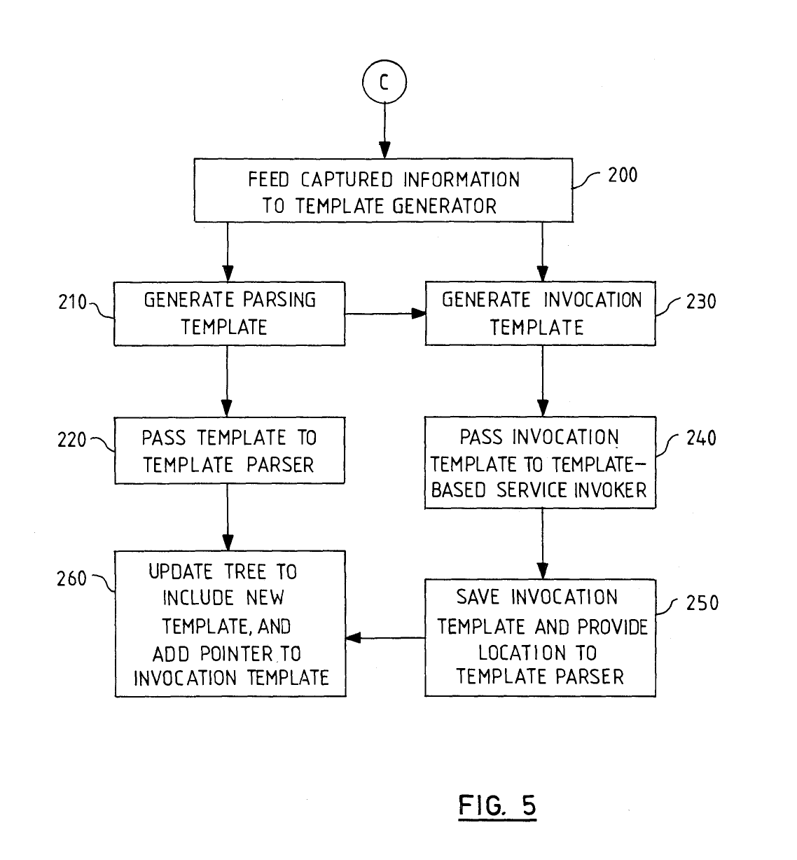

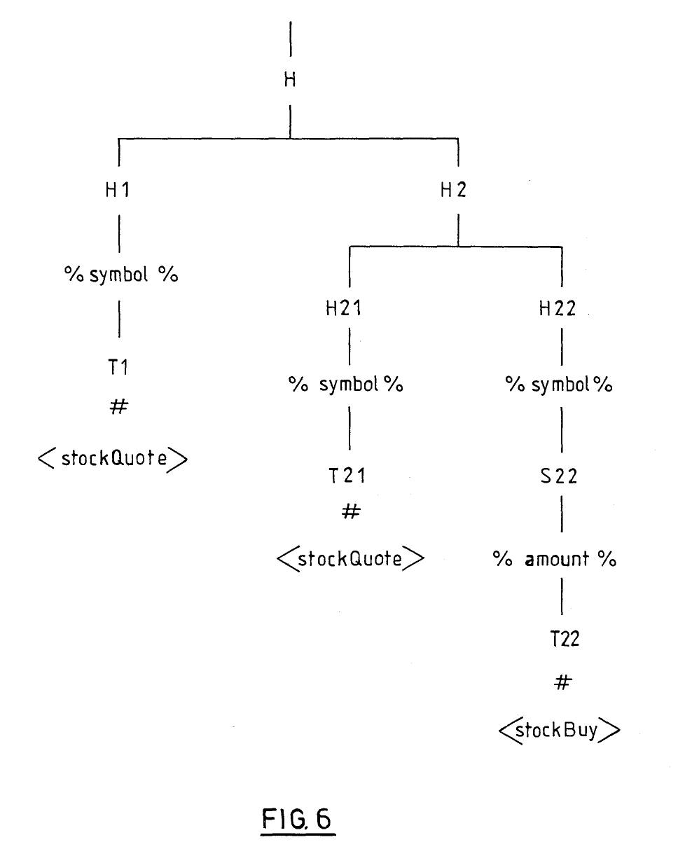

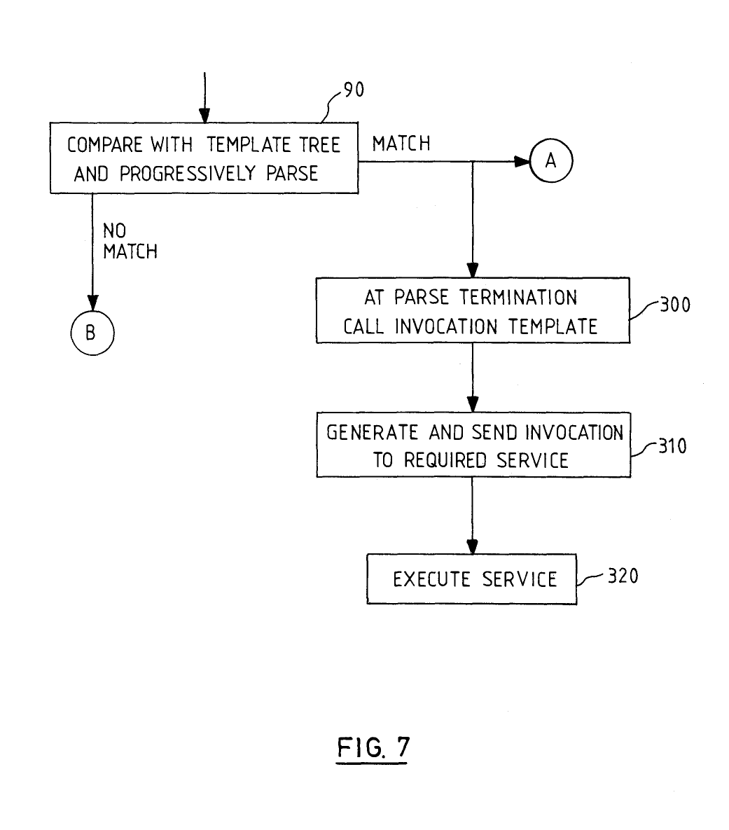

A process for generating and storing a parsing template and an associated service invocation template is described in more detail below with reference to FIG. 5 and FIG. 6. The operations of the template-based parser 60 and template-based service invoker 70 are described below with reference to FIG. 7.

First Processing Phase—Handling a New Service Request Type

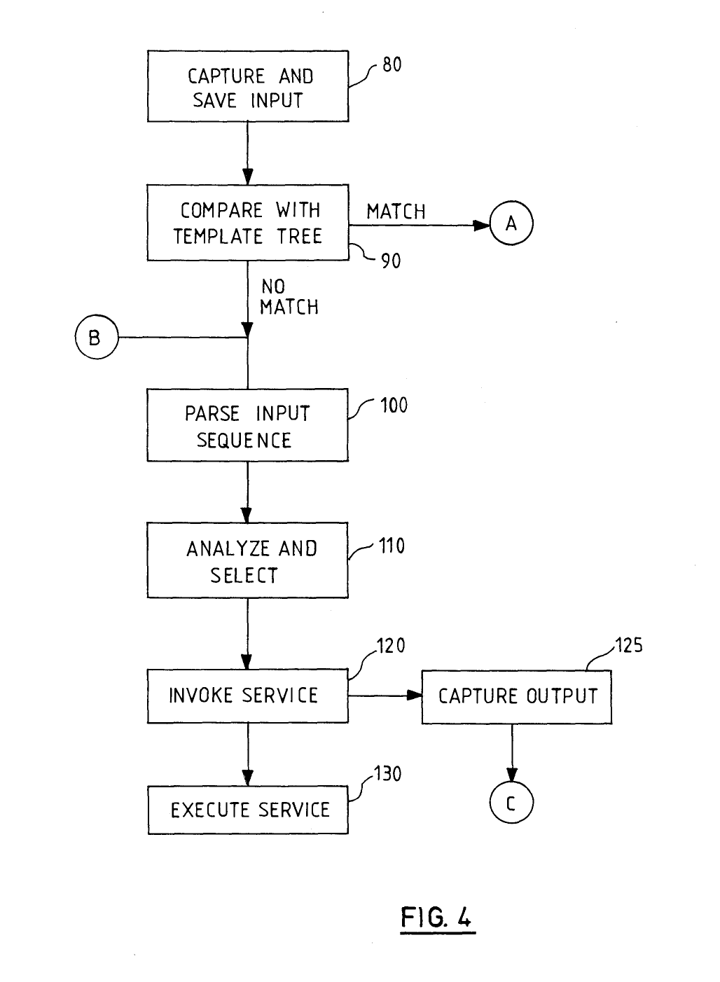

Processing of a received service request proceeds differently according to whether a request of the same type as the received request has already been received and processed. As shown in FIG. 4, a first phase of processing is similar to the sequence of FIG. 2, with the addition of data capture and template comparison steps. The capture process 40 receives an input string and saves 80 a copy of the input string into cache storage associated with the template generator 50.

Each service request received by the server apparatus is compared 90 with a template tree by a template parser (as described in detail below with reference to FIG. 7). If this is the first service request of this type to be received, there is no matching entry in the tree and the result of the comparison is a match failure. In this case, conventional steps of parsing 100 and analysis 110 are performed, followed by a service invocation step 120. As noted previously, the processing overhead involved in this conventional processing flow is significant for any large self-defining message such as a typical SOAP service request, but the addition of the comparison step 90 does not add significantly to this overhead for a typical tree depth (i.e. in the common scenario where a few message input types request one of a few services).

The conventional service invocation step 120 is modified to capture 125 the parameters and service details of the invoked service. When the service invoker 20 sends an output string to a selected service 30, the capture process 40 receives the output string and saves a copy of the output string to cache storage associated with the template generator 50.

The capture process may operate in various ways, depending how much interaction there is between the underlying infrastructure and the capture process. The details of what is captured and passed to the next phase vary between these mechanisms. A first capture mechanism requires minimal change to conventional processing (for example may be implemented in combination with the conventional Axis SOAP engine). The incoming string [a] is captured as it arrives from the data communication mechanism and before it is submitted to the SOAP engine, and the outgoing string [b] is captured as it leaves the SOAP engine before it is transmitted over a data communication link (such that there is no need to modify SOAP engine program code). Further, a trap is made at the point of service invocation, that records the service detail (for example, a class or method in Java™, or function pointer in C) [c], the parameter types and values [d], and the result types and values [e].

In an example described below, Sample 1 represents an incoming string [a], and example outgoing string [b] is shown as Sample 4. The service [c] is a method “public float getQuote (String symbol)” in class “soap.server.StockQuoteAxis”, with a single input parameter (string “XXX”) [d] and result (float) [e].

A second mechanism involves greater changes to the known Web services infrastructure. The parser and analysis/invocation engine are more tightly coupled, so that the invocation engine can output the precise positions in the input string (for example offset and length information, such as a character count) that correspond to the parameters, and the precise position in the output string that corresponds to the result. From an input sequence, input string [a] and the service [c] will be captured as in the first mechanism, but rather than capturing the parameter string (‘XXX’) the second capture mechanism will capture the information that the string is at offset 466 and has length 3 (for example).

Second Processing Phase—Setup Steps for Optimized Processing

FIG. 5 shows setup operations performed to enable optimized processing of subsequent service requests. On completion of the above-described steps (capture input string 80 and compare 90 with stored templates and identify match failure; conventional parsing 100, analysis 110, and service invocation 120; and capture of output string, parameters and service details), the captured information is fed 200 to the template generator 50.

The template generator 50 generates 210 a parsing template, by extracting elements of an input string that will be repeated in other requests for the same service from the same type of requestor. The template generator passes 220 the new template to the template-based parser 60, which adds 260 the new template to the template matching and parsing tree in cache storage. The template generator also generates 230 an invocation template and passes this 240 to the template-based service invoker 70, which saves 250 the invocation template for later use. The leaf of the new path in the template matching and parsing tree is pointed 260 at the newly generated service invocation template to associate a parsing template with a service invocation template. An output template may also be generated, when processing a request for a Web service that will send a response to the service requester via the request dispatcher. The output template is used to generate an output string from the results of execution of the required service. For one-way Web service requests, there will be no requirement for an output template. These setup steps are described in more detail below.

The template generation will vary according to the capture mechanism. In either case, the variable parts of the input string (represented by inserts/variables within the corresponding parsing template) are assumed to correspond to the parameters of the invocation, and the variable part of an output template is assumed to correspond to the result of execution of the service request by the requested service.

The first capture mechanism (as described above) leaves significant analysis to be performed for template generation. The input string must be searched for likely points that correspond to the parameters. These points are identified as insert points within a template. This search can involve a full XML reparse of the input string, with a match of XML fragments against the parameters. The XML fragments between identified ‘variable’ parameters are identified as ‘constant’ substrings for inclusion in the template. Such constant substrings within a generated and stored template can be compared with input strings to identify a match, both for selecting a parsing template and parsing using the template. For example, the capture will have established the input string (Sample 1) and input parameter (‘XXX’). As there is a single occurrence of XXX in the string Sample 1, it can break string Sample 1 at that occurrence to generate the parts of Template 1. A similar technique is used between output Sample 4 and the known result.

Alternatively, the search can involve a string search of the input string for the parameters. As another alternative, a hybrid may be used—for example using knowledge of XML structures of input strings to locate parameters, and searching for “>XXX<” rather than for “XXX”.

In general, this analysis should allow for possible ambiguities—for example if there are two parameters with identical values, or if one of the values encountered is by chance very like some other part of the XML string. A second example is where, given a known numeric value, there is not a unique string representation to search for. These issues can be resolved by generation or collection of multiple input strings and comparison of the results of the multiple capture outputs. However, in complex cases, the analysis may not be worthwhile and then a simple template is generated which (when matched) forces the conventional sequence of semantic parse, analyse and invoke execution. For example, if disambiguation is determined not to be worthwhile, identification of more than one potential match with an input string may be interpreted as a match failure leading to initiation of the conventional parse, analyze and invoke sequence.

The second capture mechanism (described above) collects more precise information of the correspondence between parameters (of the result) and strings, so that template generation is relatively straightforward; involving breaking the captured input string at the offsets identified by the parameter positions and lengths in the parameter capture.

The capture and template generation phases may be performed at deployment time, on receipt of a first message or service request of a particular type at a particular server (and then persistently cached for future service executions at that server), or in response to a first call to a particular server instance.

In some cases, there are additional ‘variable’ parts of a template that do not correspond to parameters. For example, a client may encode a sequence number into each request (such as for use in debugging). This can be resolved by putting extra semantic knowledge of the variations expected into the template generator. In an implementation in which the capture/template generation mechanism is relatively tightly coupled to the original parsing/analysis/invocation mechanism, this can be handled by additional feedback of information parsed by the parsing engine that is ignored by the analysis engine.

The template generation process produces three templates:
1) the parsing template [step 210]—for example Template 1 shown below. The new template is folded with other parsing templates into a parsing tree [step 260] as described below.
2) the invocation template [step 230] (described below).
3) the output template—for example Template 4 below.

Each invocation template is associated with a related parsing template, by including 260 a pointer to the invocation template at a termination point of the parsing template.

Example parsing templates are shown below, and their arrangement in a matching and parsing tree is then described. The invocation and output templates are then described.

Generating Parsing Templates and a Matching/Parsing Tree

The following are two sample SOAP messages from the same client for an example stockQuote service (with example company names shown in bold text to highlight the only differences between the two messages).

Sample 1:

<?xml version=“1.0” encoding=“utf-8”?><soap:Envelope
xmlns:soap=“http://schemas.xmlsoap.org/soap/envelope/”
xmlns:soapenc=“http://schemas.xmlsoap.org/soap/encoding/”xmlns:tns=
“http://dotnet.server”
xmlns:types=“http://dotnet.server/encodedTypes”
xmlns:xsi=“http://www.w3.org/2001/XMLSchema-
instance“xmlns:xsd=http://www.w3.org/2001/XMLSchema><soap:Body
soap:encodingStyle=
http://schemas.xmlsoap.org/soap/encoding/><tns:stockQuote><symbol
xsi:type=“xsd:string”>XXX</symbol></tns:stockQuote>
</soap:Bodyx/soap:Envelope>

Sample 2:

<?xml version=“1.0” encoding=“utf-8”?><soap:Envelope
xmlns:soap=“http://schemas.xmlsoap.org/soap/envelope/”
xmlns:soapenc=“http://schemas.xmlsoap.org/soap/encoding/”
xmlns:tns=“http://dotnet.server”
xmlns:types=“http://dotnet.server/encodedTypes”xmlns:xsi=
“http://www.w3.org/2001/XMLSchema-
instance” xmlns:xsd=http://www.w3.org/2001/XMLSchema><soap:Body
soap:encodingStyle=
http://schemas.xmlsoap.org/soap/encoding/><tns:stockQuote><symbol
xsi:type=“xsd:string”>IBM</symbol></tns:stockQuote></soap:Body>
</soap:Envelope>

The service request type of these two requests is represented as a template as follows: Template 1

1) <?xml version=“1.0” encoding=“utf-8”?><soap:
Envelope
xmlns:soap=“http://schemas.xmlsoap.org/soap/envelope/”
xmlns:soapenc=“http://schemas.xmlsoap.org/soap/encoding/”xmlns:tns=
“http://dotnet.server”
xmlns:types=“http://dotnet.server/encodedTypes”xmlns:xsi=
“http://www.w3.org/2001/XMLSchema-
instance” xmlns:xsd=http://www.w3.org/2001/XMLSchema><soap:Body
soap:encodingStyle=
http://schemas.xmlsoap.org/soap/encoding/><tns:stockQuote><symbol
xsi:type=“xsd:string”>
2) %symbol%
3) </symbol></tns:stockQuote></soap:Body></soap:Envelope>

All requests to the same stockQuote service from clients implemented using the same technologies are likely to generate requests matching this template. Even whitespace within messages generated from similar clients is typically the same.

However, requests to the same service from a different client technology often differ in detailed syntax. In such cases, differences within a new service request prompt the template generator to generate a new template for this new service request type. For example, a second client may submit a similar request to the request shown above as shown below.

Sample 3:

<?xml version=“1.0” encoding=“UTF-8”?>.<soapenv:Envelope
xmlns:soapenv=“http://schemas.xmlsoap.org/soap/envelope/”
xmlns:xsd=“http://www.w3.org/2001/XMLSchema”xmlns:xsi=
“http://www.w3.org/2001/XMLSchema-
instance”><soapenv:Body><ns1:stockQuote
soapenv:encodingStyle=“http://schemas.xm lsoap.org/soap/encoding/”
xmlns:ns1=http://dotnet.server><symbol
xsi:type=
“xsd:string”>XXX</symbol>/
</ns1:stockQuotex/soapenv:Body></soapenv:Envelope>

In the above examples, one client implements Axis technology whereas the other client implements .NET technology, sending request messages based on the same WSDL.

A template generated for the second client is as follows:

Template21:

1) <?xml version=“1.0”
encoding=“UTF-8”?>.<soapenv:Envelope
xmlns:soapenv=“http://schemas.xmlsoap.org/soap/envelope/”
xmlns:xsd=“http://www.w3.org/2001/XMLSchema”xmlns:xsi=
“http://www.w3.org/2001/XMLSchema-
instance”><soapenv:Body><ns1:stockQuote
soapenv:encodingStyle=“http://schemas.xmlsoap.org/soap/encoding/”
xmlns:ns1 =http://dotnet.server><symbol xsi:type=“xsd:string”>
2) %symbol%
3) </symbolx/ns1:stockQuote></soapenv:Body></soapenv:Envelope>

A second example service is provided for buying company shares. Let us assume that the second client (only) uses the stockBuy service, using a new template:

Template22:

1) <?xml version=“1.0”
encoding=“UTF-8”?>.<soapenv:Envelope
xmlns:soapenv=“http://schemas.xmlsoap.org/soap/envelope/”
xmlns:xsd=“http://www.w3.org/2001/XMLSchema”xmlns:xsi=
“http://www.w3.org/2001/XMLSchema-
instance”><soapenv:Body><ns1:stockBuy
soapenv:encodingStyle=“http://schemas.xmlsoap.org/soap/encoding/”
xmlns:ns1=http://dotnet.server><symbolxsi:type=“xsd:string”>
2) %symbol%
3) </symbolxamount><xsi:type=“xsd:integer”>
4) %amount%
5) </amount></ns1 :stockBuy></soapenv:Body></soapenv:Envelope>

Having generated a new template, this new template is added to a parse control tree structure. One advantage of building a parse control tree is enablement of parsing simultaneously with a template matching operation for selection of the parsing template. Trees are known for use in conventional SLR parsing, but the conventional systems have not arranged a plurality of matching and parsing templates in a tree.

The tree is built by identifying matches between common parts of relevant templates, and using the common parts (and inserts representing variables) as nodes of the tree. The common parts identified as nodes of the tree may be XML fragments or byte string fragments, for example. FIG. 6 shows the structure of the matching and parsing tree for the example templates described above. The following is a key to the alphanumeric characters corresponding to labelled nodes of the tree shown in FIG. 6:

```
  H (common header) =
<?xml version=“1.0” encoding=“utf-8”?><soap:Envelope
xmlns:soap=“http://schemas.xmlsoap.org/soap/envelope/” xmlns:
  H1 (subheader for Template1) =
:soapenc=“http://schemas.xmlsoap.org/soap/encoding/”xmlns:tns=“http://dotnet.server”
xmlns:types=“http://dotnet.server/encodedTypes”
xmlns:xsi=“http://www.w3.org/2001/XMLSchema-
instance”xmlns:xsd=http://www.w3.org/2001/XMLSchema><soap:Body
soap:encodingStyle=“http://schemas.xmlsoap.org/soap/encoding/”><tns:stockQuote><
symbol
xsi:type=“xsd:string”>
  T1 (tail for Template1) =
</symbol></ns1:stockQuote></soapenv:Body></soapenv:Envelope>
  H2 (common subheader for Template21/Template22) =
xsd=“http://www.w3.org/2001/XMLSchema”
xmlns:xsi=http://www.w3.org/2001/XMLSchema-instance><soapenv:Body><ns1:stock
  H21 (header for Template21) =
Quote soapenv:encodingStyle=“http://schemas.xm lsoap.org/soap/encoding/”
xmlns:ns1=http://dotnet.server><symbol xsi:type=“xsd:string”>
  T21 (tail for Template21) =
</symbol></ns1 :stockQuote></soapenv:Bodyx/soapenv:Envelope>
  H22 (header for Template22)=
Buysoapenv:encodingStyle=“http://schemas.xmlsoap.org/soap/encoding/”
xmlns:ns1 =http://dotnet.server><symbolxsi:type=“xsd:string”>
  S22 (separator for Template22)=
</symbol><amountxsi:type=“xsd:integer”>
  T22 (tail for Template22) =
</amount></ns1 :stockBuy></soapenv:Body></soapenv:Envelope>
```

Each of node labels H, H1, H2, T1, H21, H22, T21, S22, T22 indicates a ‘constant’ substring (i.e. a substring expected to repeat, at least for a particular type of client requesting the same service).

The syntax % % is used to indicate an insert/variable to be filled in during a parse.

Symbol # is used to indicate a point at which the input string should be exhausted (fully matched).

Syntax < > is used to indicate the action for a termination point.

The tree of FIG. 6 represents the current set of templates for known input string patterns for the example templates described above. The tree is not required to follow conventional tokenisation (for example, the tokens stockQuote and stockBuy have been split between template parts H2 and H21/H22). In an embodiment in which parsing uses byte strings instead of character strings, the template parts may split in the middle of a multibyte character.

Given an arbitrary set of templates, it will not always be possible to fold them into a parse tree that can be used to parse and validate input strings in the single pass described above (as in the case of SLR(O)). A more complicated parsing mechanism such as SLR(n) would be needed. The techniques described above could be extended to cover such scenarios. However, there is no requirement for SLR(n) parsing with XML input strings and typical Web services.

Generating Service Invocation Templates

In general, an invocation template contains details including identification of:

[a]an object (or class of object) to be invoked;

[b]a method to be invoked; and

[c]parameter types and values.

A service invocation template is generated 230 from service requirements identified in the template-based parsing step, by reference to parameters and service details captured (in steps 80,125 as described above) when a first service invocation is performed for the same service. The generated invocation template is then passed 240 to the template-based service invoker where it is stored 250 in association 260 with the corresponding parsing template.

Details of the invocation template vary between different implementations. For example, where the service is implemented in C, a service invocation template can consist of:

1) a function pointer to the implementation of the method; and

2) an ordered list of parameters, with each parameter being represented by:

a. an encoding of the datatype of the parameter
b. the number of the variable slot within the parsing template that corresponds to this parameter (parseSlot).

In a Java™ implementation, a class object and method object may be used in place of the function pointer.

In the above example the service invocation template will contain:

Class=sample.server.StockQuote

Method=getQuote( )

Parameters={type=string, parseSlot=1}

Output Templates

Generation of output templates is very similar to generation of input templates. However, the input templates are folded into a single tree (including many templates) as described above, to permit simultaneous matching. This is desirable because the input template is not known when the input string arrives. By the time output is generated, the template to use is already known, and so there is no need to arrange output templates into a matching tree. Also, output templates are used for string generation (serialization) by insertion of appropriate result, rather than for string parsing.

The XML of Sample 4 below is a sample of an output in response to the input of Sample 1: Sample 4:

```
<?xml version=“1.0”
encoding=“UTF-8”?> <soapen v:
Envelope
  xmlns:soapenv=“http://schemas.xm lsoap.org/soap/envelope/”
  xmlns:xsd=“http://www.w3.org/2001/XMLSchema”
  xmlns:xsi=“http://www.w3.org/2001/XMLSchema-instance”>
  <soapenv:Body>
  <ns1 :getQuoteResponse
  soapenv:encodingStyle=“http://schemas.xm lsoap.org/soap/encoding/”
  xmlns:ns1 =“soap.server.StockQuoteAxis_Wmq” >
  <getQuoteReturnxsi:type=“xsd:float”>
    95
  </getQuoteReturn>
</ns1 :getQuoteResponse>
</soapenv:Body>
</soapenv:Envelope>
```

The equivalent output template (Template 4) is as follows: Template 4:

```
  1) <?xml version=“1.0” encoding=“UTF-8”?>
    <soapenv:Envelope
    xmlns:soapenv=“http://schemas.xmlsoap.
    org/soap/envelope/”
xmlns:xsd=“http://www.w3.org/2001/XMLSchema”
xmlns:xsi=“http://www.w3.org/2001/XMLSchema-instance”>
<soapenv:Body>
  <ns1 :getQuoteResponse
  soapenv:encodingStyle=“http://schemas.xm lsoap.org/soap/encoding/”
  xmlns:ns1 =“soap.server.StockQuoteAxis_Wmq”>
  <getQuoteReturn xsi:type=“xsd:float”>
2) %result%
3)</getQuoteReturn>
  </ns1 :getQuoteResponse>
  </soapenv:Body>
</soapenv: Envelope>
```

Although the solution described in detail above relates to a server-side implementation, with particular reference to the example of a Web services dispatcher, similar techniques can be used at the client end of a typical request/response pair. In a client-side implementation, the request (client output) is created from a request template by insertion of the appropriate parameters. The response (client input) is parsed from a response template. Often there will be only one response template (a trivial response template parsing tree); but this will not always be the case as, for example, where the client must cope with both correct and fault responses, or where an intermediate network entity forwards different requests to different services implementations which respond with syntactically different responses. The client side templates can be implemented in the same way as the server side templates except that client usage (parsing/string generation) is a reverse sequence of the server usage. For example, request Template 1 shown above will be the output template and response Template 4 will be the input template.

Third Phase—Optimized Processing for Recognized Request Types

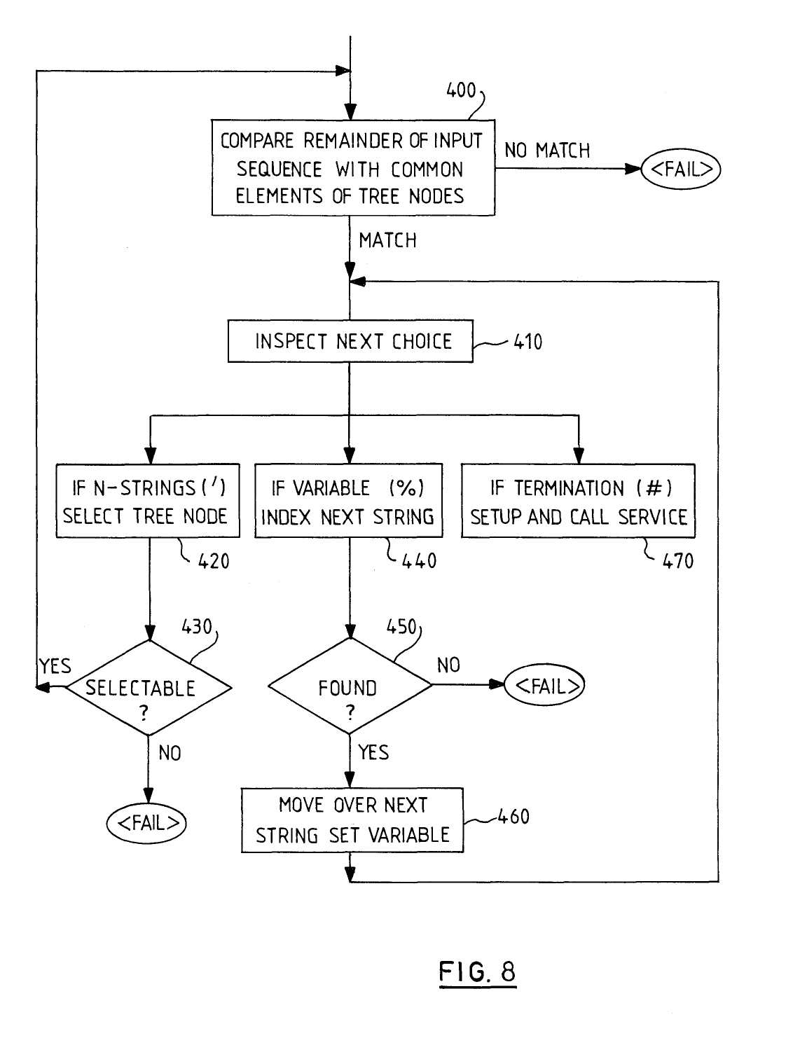

FIGS. 7 and 8 show how a parsing template and its associated service invocation template are used, for service requests of the same type as the service request that prompted their generation. As described above with reference to FIG. 4, each new service request is compared 90 with the matching and parsing tree. If this service request is a type which has been received previously, comparison of the input string representing the request with the tree will identify a matching template.

A suitable parsing algorithm is a non-tokenised SLR(O) parser. The operations of the parser are represented in FIG. 8. Such a parser can progress through the tree using a set of string-based parse operations performed on substrings of a received input string—comparing an input string with constant substrings and inserts/variables at each node of the tree using the operations of: 1) match—determine whether the beginning of the remainder of an input string is equal to a given constant substring within the tree;

2.) choice—inspect next node in the tree to determine whether the node is: [a] a “choice” node (′), [b] a variable (%), [c] a termination (#); and

3) index—find next occurrence of a constant substring in remainder of input string.

The match and parse operation using the template tree proceeds as follows. An input string is compared 400 with a first common substring corresponding to a common header node of the tree. If the input string does not match the first common substring, a match failure is reported and conventional semantic parsing is performed. If there is a match with the first common substring, the saved result of previously parsing this first substring is determined to be valid for this request (avoiding the need for a semantic parse of the substring), and then the template-based parsing continues. The tree is inspected 410 to determine whether the next step through the tree requires a choice between potentially matching substrings, a variable (for example, if the next element is preceded by %) or whether a termination point (#) has been reached.

If the matching and parsing tree requires a common substring 420 (one specific substring or one of N substrings) as the next element of an input string, a comparison is performed 430 to identify a matching substring. If the attempt to identify a match fails at any time before successful termination, the system reverts to conventional semantic parsing. However, if this comparison is successful and a matching node is selected 430, the previous parsing result is determined to be valid and the matching and parsing continues. The remainder of the input string is again compared 400 with the matching and parsing tree.

If the tree inspection 410 identifies a variable 440 as the next element of the tree, the parser scans the tree for a next string following the variable and indexes for that string. A determination can then be made 450 of whether the next-required string is found to match. As stated above, a match failure at this point prompts the system to revert to conventional semantic parsing.

If the tree inspection 410 identifies a termination as the next node of the tree, the results of the parsing are used to setup and send 470 a call to the template-based service invoker (as described below).

A number of standard tree search algorithms can be used to control the selection of a tree node, for example as described in “Art of Computer Programming, Volume 3: Sorting and Searching (2nd Edition)”, Donald E. Knuth, 1998, Addison-Wesley. A first option is to inspect just the next byte (or character) of the input string, and select a tree branch based on that byte or character. A second option parses a fixed number of bytes (characters) each time and then selects a branch (using hashing for example). A third example parses forward to a given byte (or character) within the string—for example scanning for the next ‘<’ character—and selects a branch based on the intervening substring (for example using hashing).

As shown in overview in FIG. 7 and in detail in FIG. 8, when a parsing template match is identified, the compare and parse step 90 uses the matching template to extract service requirements from an input string. On successful termination of parsing, the template-based service invoker is called 300 directly from the template-based parser 60-passing the parameters extracted from the input string during the parsing step, as an array of character string inserts, in the order in which they appear in this service request type. In a first implementation, the ‘inserts’ array is in the form of a byte array (may be a Unicode Transformation Format (UTF) string). Since the leaf node of a path in the template matching and parsing tree points at the associated invocation template, this call 300 to the service invoker effectively selects a service invocation template, and the service requirements identified in the parsing step are entered 310 into the selected template by the template-based service invoker to generate a service invocation request

To set up a service call, the inserts are converted to objects of the correct type (and de-escaped), and are arranged in the correct order to form an object array (xparms). The pattern that this arrangement must conform to was collected during the first phase of processing (when processing a first request of this type) and assembled in the second setup phase.

A new target object is now created, using the class determined in the first pass (myclass), (although in another implementation this can be avoided as the target object of the first pass can be reused, depending on the semantics of the object). The method determined and saved on the first pass (mymethod) is also used:

Object o=myclass.newInstance( );
Object rr=mymethod.invoke(o, xparm);

An alternative way for the template invoker to work is to generate server proxy code for each method, and providing the proxy code with a fixed signature to make it easy to call. For example:

public static String getQuoteServerProxy (byte[ ] variableTable[ ] throws
Exception {
String parm1 = new String(variableTable[0],“utf-8”);
StockQuoteAxis o = new StockQuoteAxis( );
float f = o.getQuote(parm1);
String r = “” + f;
return r;
}

The service invocation request, formatted by the template-based parser and template-based service invoker for execution by the required service, is sent to the required service and executed 320.

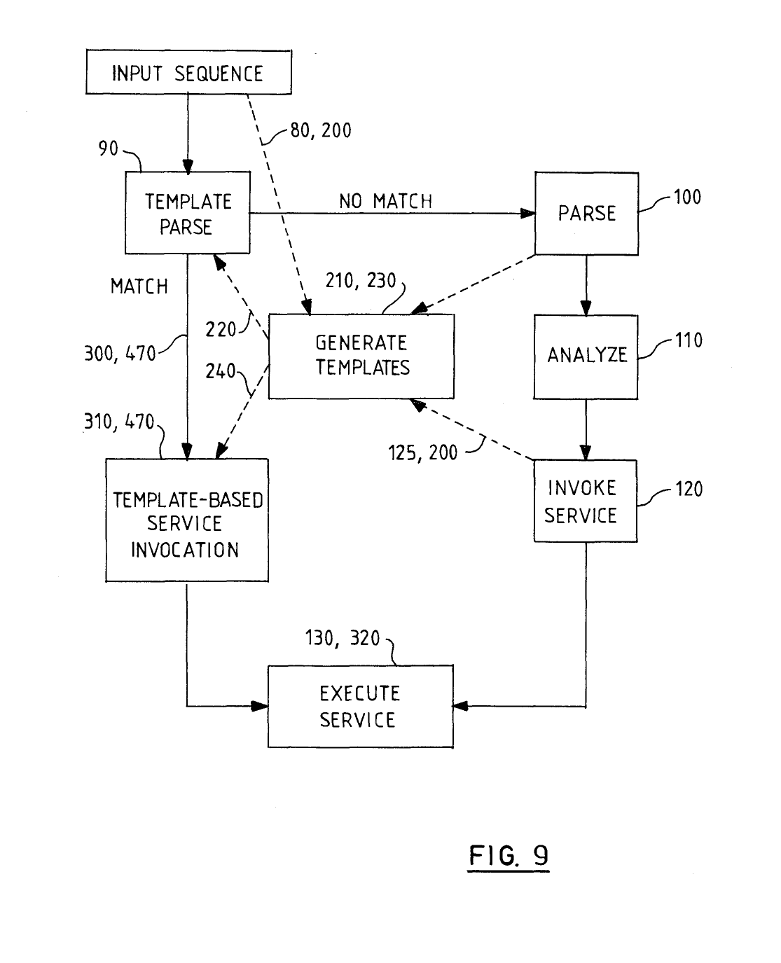

FIG. 9 provides a schematic overview of the three processing phases described above. A first phase comprises a capture 80 of an input string and an attempted template parse 90 which results in a match failure. This is followed by a conventional semantic parse 100 of the input string, analysis 110 of the results of the parsing, and invocation 120 of a service. The outputs of the parse and invoke steps are captured 125 and provided 200 to a template generator. The service is then executed, potentially sending a response to the service requestor. An output template may be used for optimized handling of the response.

A second phase of processing generates a parsing template (step 210) and an invocation template (step 230), and updates 220 a matching and parsing tree to include the new parsing template. The new invocation template is provided to the template-based service invoker and a pointer is added at a parsing termination point of the matching and parsing tree to associate the parsing and invocation templates. A third optimized phase of processing is performed on receipt of a subsequent input string which matches the first input string. The attempted template parse 90 is successful, and partially avoids repetitious semantic parsing. At successful termination of the match and parse operation, a call 300, 470 to the template-based service invoker includes an identification of the associated invocation template as well as the results of the parsing step. The required service is invoked and executed with far less analysis than in the conventional processing sequence (first phase).

As noted above, a number of techniques can be used for capturing invocation information for use by the service invoker. A first technique captures information by modification of a service invoker, and in one example implementation, the capture mechanism is added to java.lang.reflect.Method.invoke( ). This has the advantage of being written once to cover many cases, but a disadvantage of being relatively intrusive on the basic underlying infrastructure.

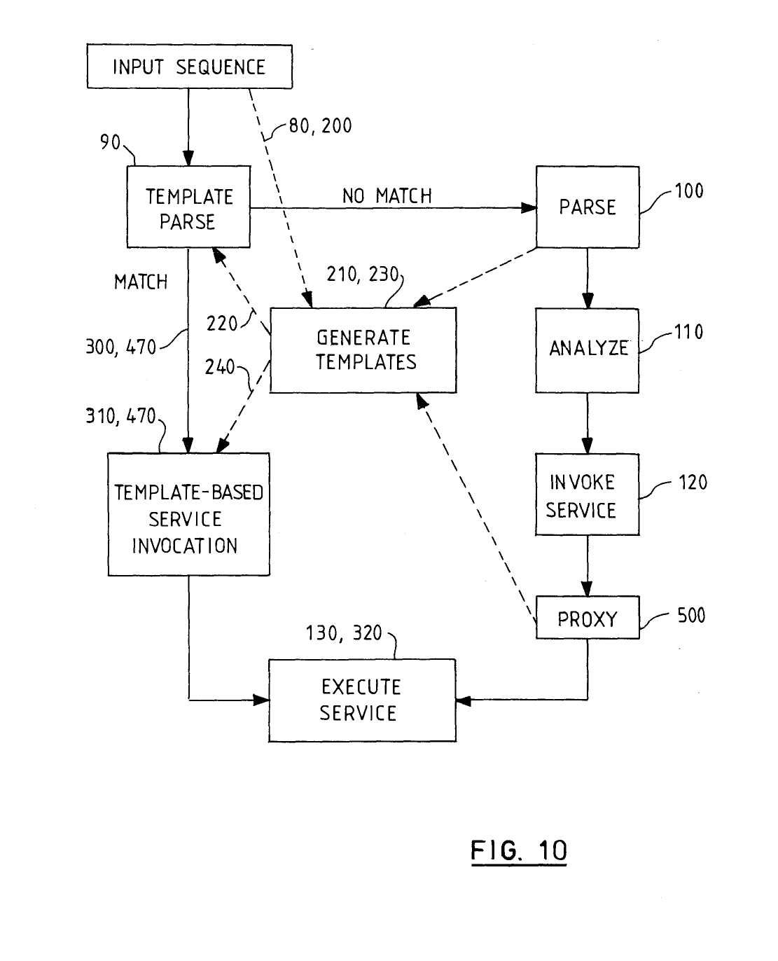

In an alternative implementation, the deployment infrastructure generates server-side proxies (additional to existing client-side proxies) and this enables decisions to be made at the proxies if certain services should never be invoked using the template-based parse and direct template-based service invocation described above. FIG. 10 provides a schematic overview of the three processing phases (similar to FIG. 9) for an implementation of the invention using server-side proxies 500 for each invoked service. In this embodiment, the capture of service invocation details for the first phase of processing may be implemented at the proxy 500.

1. A method for processing service requests in a data processing network, comprising the steps of:
comparing a received service request with a set of stored parsing templates and applying a matching parsing template to extract service requirements information from the received service request;
identifying a service invocation template associated with the matching parsing template; and applying the associated service invocation template to invoke a service matching the service requirements information.

2. A method according to claim 1, including the steps of:
processing a service invocation that results from processing a first received service request, to identify a method and any required parameter types of an invoked service, and generating a service invocation template comprising the method and any required parameter types;
storing the generated service invocation template, in association with a parsing template, for invoking a service in response to receipt of subsequent service requests of a type matching the received service request.

3. A method according to claim 2, wherein said processing of a service invocation includes identifying an invoked service-provider object or class of object, identifying an invoked method implemented by said object or class of objects, and identifying any required parameter types.

4. A method according to claim 2, including the steps of:
generating the associated parsing template by processing a received input sequence of a service request to identify constant elements and variables within the received input sequence, and generating a template comprising said constant elements and insert positions for inserting variables;
storing the generated parsing template, for parsing subsequent service requests of a type matching the received service request, together with a pointer to the associated service invocation template.

5. The method of claim 1, wherein the received service request is an XML message.

6. The method of claim 5, wherein the received service request is a SOAP message.

7. The method of claim 1, wherein the set of parsing templates are stored as a matching and parsing tree, the nodes of the tree comprising common elements, variable identifiers, and parsing termination points.

8. The method of claim 7, wherein each parsing termination point includes an identifier for identifying an associated invocation template.

9. A method for processing service requests at a service listener system within a data processing network, the method comprising:
analysing a first service invocation that is generated in response to a first service request of a first type, to identify service invocation elements that are common to service invocations resulting from service requests of the first type; and
generating a service invocation template comprising the common service invocation elements, and storing the service invocation template for use with other service requests of the first type.

10. The method of claim 9, further comprising:
analysing the first service request to identify elements that are common to service requests of the first type;
analysing a result of parsing the first service request to identify results of parsing said common elements;
generating a parsing template comprising the results of parsing the common elements; and
storing the parsing template in association with the service invocation template, for use with other service requests of the first type.

11. A method for processing input sequences in a data processing network, comprising the steps of:
comparing a received input sequence with a stored set of parsing templates and applying a matching parsing template to parse the received input sequence, to identify requirements of an operation to be performed subsequent to said parse step; and
identifying a second stored template, associated with the matching parsing template, for initiating the subsequent operation; and
applying the second stored template to initiate the subsequent operation.

12. The method of claim 11, wherein the method is performed by a services request listener and the input sequences are services requests.

13. The method of claim 12, wherein the subsequent operation is invocation of a service and the second stored template is a service invocation template.

14. A data processing apparatus comprising:
at least one service provider; and
a service request dispatcher comprising: a template generator for generating parsing templates and associated service invocation templates, a template-based parser, and a template-based service invoker.

15. A method for processing input sequences at a service requestor system within a data processing network, wherein an input sequence is received ay the service requester system in response to a service request, the method comprising:
analysing a first input sequence received in response to a first type of service request, to identify elements of the first input sequence that will be constant between the first input sequence and other input sequences received in response to service requests of said first type; and
generating and storing a response parsing template comprising the constant elements, for handling input sequences received in response to service requests of said first type.

16. The method of claim 15, further comprising:
identifying input sequences received in response to service requests of the first type,
and parsing identified input sequences using the response parsing template.

17. A data processing apparatus comprising:
a service requester; and a template generator for performing the method of claim 15.

18. The data processing apparatus of claim 17, further comprising: a response handler for performing the identifying and parsing steps of claim 16.
